(19) United States
(12) Patent Application Publication
(10) Pub. No.: US 2008/0230248 A1
(43) Pub. Date: Sep. 25, 2008

(54) Floating Piston _ an Oil Pressure Oscillation Dampening Device for Rock Drilling and Breaking Hammers

(76) Inventor: DONGMIN NIU, Mississauga (CA)

Correspondence Address: DONGMIN NIU, 3125 FIFTH LINE W., UNIT 76, MISSISSAUGA, ON, L5L-3S8, CA

(21) Appl. No.: 12/049,275

(22) Filed: Mar. 15, 2008

Related U.S. Application Data
(60) Provisional application No. 60/896,366, filed on Mar. 22, 2007.

(51) Int. Cl. B25D 17/24

(52) U.S. Cl. 173/206

(57) ABSTRACT

Floating pistons are implemented in hydraulic rock drilling hammer, or hydraulic hammer breaker, or fluid DTH hammer. The chambers confined by the impact piston and the body case are connected via ports and the floating pistons. The pistons balance the pressure difference when pressure pulsation happens in the chambers during the reciprocating movement of impact piston. It dampens the pulsation, prevents cavitations and assists the forwarding and returning movement of impact piston. The device will also be potential to increase the efficiency and impact power of hammers.

This application claims priority under 35 U.S.C. §119(e) to U.S. Provisional Application No. 60896366, filed Mar. 22, 2007, entitled “Floating Piston_A Hydraulic Rock Drills Oil Pressure Dampening Device”, the entire contents of which are incorporated herein by reference.

### APPLICATION FIELD

The present disclosure relates to bore hole drilling of an earth formation by percussion drilling with a hydraulic top hammer drills, down-the-hole (DTH) drilling, as is also called in-the-hole (ITH) hammer drilling, with a hammer that is driven by fluid; and to earth formation breaking by hydraulic hammer breakers.

### BACKGROUND

Hydraulic top hammer drilling is used, for example, in mining and construction industries. In general, a reciprocating piston in a hammer or, as is also called, drifter repeatedly hits the rear face of shank adapter. The impact force is transmitted to bit through drill string. Bit impacts rock, which is broken under the impact force of the bit.

Hydraulic hammer breaker is used, for example, in mining and construction industries. In general, a reciprocating piston in a hammer repeatedly hits the rear face of impact tool, causing the tool to impact rock, which is broken under the impact force of the tool.

Down-the-Hole is used, for example, in mining and construction industries in oil and gas exploration and retrieval operations. In general, a reciprocating piston in the hammer repeatedly hits the rear face of the bit, causing the bit to impact rock, which is broken under the impact force of the bit. DTH hammers can be operated by water and fluid means.

The reciprocating motion and impact of piston in a hammer actuates significant oil pressure oscillation in hydraulic system. It was found that the peak pressure variation could double the mean value in some case. With reference to previous art of design (FIG. 1), the piston 4 accelerates to a desired velocity and strikes objective 18 (shank, bit or other tools). It rebounds immediately after the impacting, works as a pump at the instant of rebounding and will push the oil in chamber 1 flowing out through port 16. The rebounding happens over a very short period of time. Therefore the suddenly flowing out oil meets strong restriction generates a pressure pulse. The extent of the pulsation depends on the position of control valve 14 which gives different opening size to flowing out oil. The pulsation is small when the valve fully open to tank T. The similar phenomenon happens in the system of hydraulic hammer breaker and fluid controlled DTH hammers.

At the same time, significant pressure drop happens on the other side of the piston 4 because the oil flow volume supplying via port 17 to chamber 2 can not match the rebounding speed of piston 4 due to the resistance to the oil flow. Hence, cavitations may happen in chamber 2 and connected circuits.

Actually, piston 4 should return immediately after hit object 18. The returning is by the action of oil pressure in the chamber 2, which is controlled by a distribution valve 14. Piston 4 and object 18 can not always meet at exactly same position because of the different working conditions encountered. Also, it is the practical difficulty of precise machining and actual shifting speed of distribution valve that makes it almost impossible to respond the piston's rebounding precisely to avoid the happening of oil pressure pulse and cavitations.

When impact piston 4 reaches its rearmost rear position, it stops as the distribution valve 14 changes the oil supply. Significant pressure pulse in the rear chamber 1 is also created due to the inertia of the piston 4.

Usually accumulators are used to dampen the pressure pulsation. However, they still can not effectively solve the pressure oscillation and cavitations problems. It is a ‘passive’ way and it will also cause some pressure or efficiency drop in the hydraulic system.

### BRIEF DESCRIPTION OF THE DRAWINGS

The objects and advantages of the invention will become apparent from the following detailed description in connection with the accompanying drawings:

FIG. 1 is an illustration of prior art of hydraulic drifter;

FIG. 2 is an illustration of fundamental concept of floating piston;

FIG. 3 is an illustration of floating piston to be built in the impact piston of a DTH hammer or a hydraulic hammer breaker;

FIG. 4 is an illustration of floating piston to be used in a top hammer hydraulic drifter to dampen the pressure pulse caused by impacting of piston;

FIG. 5 is similar to FIG. 4 plus an illustration of a floating piston to be used to dampen the pressure pulse caused by inertia of returning of impact piston.

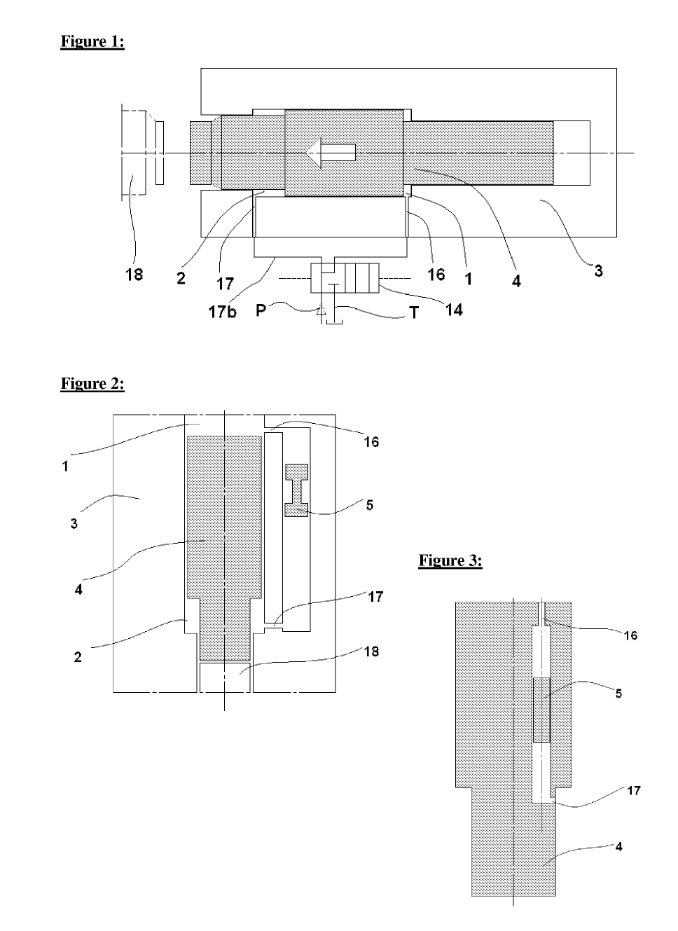

### THE DESCRIPTION OF THE INVENTION

The fundamental concept of the invention is to use a floating piston 5 to balance the pressure difference when pulsation happens in chambers 1 and 2 to dampen the pressure oscillation, as is shown in FIG. 2, and to utilize the pulsation to assist the movement of impact piston 4 and to prevent the cavitations in the circuits. Chamber 1 and chamber 2 are connected via oil ports 16, 17 and floating piston 5. Chamber 2 is always connected to pressure oil. When pressures are equal in both chamber 1 and 2, piston 5 is in floating state while impact piston 4 moves downwards and hit the object 18. The piston 4 rebounds after impacting. It works as a pump and generate a pressure pulse in chamber 1 at the instant, pushes the floating piston 5 downwards. The movement of floating piston 5 can dampen the pressure pulse and also acts as a pump to pressurize the oil in chamber 2, pushing the impact piston 4 upwards. When the oil in chamber 1 goes to tank both pistons 4 and 5 return to upper position. When the pressure oil is piloted to chamber 1 again, impact piston 4 is pushed downwards, the next impact cycle starts. The piston 5 stays at the upper position because both of its ends have the same pressure until impact piston 4 hits the object 18, starts the next dampening cycle. The concept of such a floating piston can be used for hydraulic top hammer drifters, hammer breakers and fluid driven down the hole (DTH) hammers.

By the art of design, the pressure pulse is potentially dampened by the floating piston 5. It also assists to return the impact piston 4 for following working cycle. It will possibly increase the impact frequency and the impact power of hammer without other parameters change. The floating piston 5 should be located as close as possible to the oil chambers 1 and 2 and it should also be light in mass for fast responding. The floating piston can be located in the case body 3 of a hammer or in a separate unit attached to it.

The floating piston 5 can also be built inside the impact piston 4, which is likely used in DTH or breaker hammer, as is shown in FIG. 3.

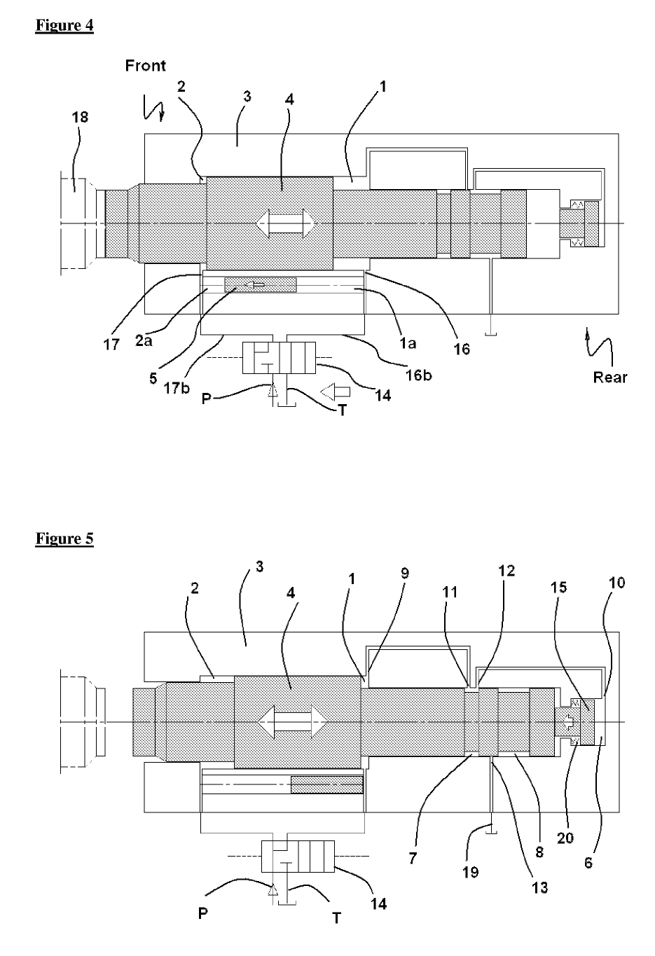

An exemplary method of the art is to use it in hydraulic drifter. Refer to FIG. 4, the impact piston 4 rebounds as soon as it hits shank 18. Pressure pulse will be created in chamber 1. The extent of the pulsation depends on the position of the distribution valve 14. The control of the distribution valve is defined by prior art.

1). When valve 14 is at a position that it has not shifted during the contacting of piston and shank, both chamber 1 and 2 are connected to P. However, the pressure in chamber 1 is higher than that in 2 because of the restriction of channel 16b and 17b to the oil flow. Piston 5 will be pushed forwards by the higher pressure from chamber 1. The movement would dampen the pressure in 1 and increase the pressure in 2 and assisting the returning of piston 4.
2). When valve 14 is in the process of shifting, the chamber 1 is either not fully cut off from pressure line P, or completely isolated, or only connected to return line T with very small opening. There will be very strong restriction for the oil flow in 16b and 17b. The pulse pressure in chamber 1 can be very high. The piston 5 will move towards front side, dampen the pressure in chamber 1 and increase the pressure in 2 and assist the returning of piston 4.
3). When at the position that chamber 2 connects to pressure line P and chamber 1 to return line T. Both piston 4 and 5 moves towards rear side, little pulsation created.

Aforementioned all three situations can happen during the reciprocating process, as was discussed in section [0008].

An exemplary application of floating piston is to use a piston 15 behind the impact piston 4 in a top hammer drifter to damp the oil pressure pulse caused by the inertia of piston 4. Refer to FIG. 5, the distribution valve 14 shifts to shown position when impact piston 4 returns to the rearmost rear position. Both chamber 2 and 1 are connected to pressure line P. The annular area 1 is bigger than 2, which is normal in current art of design, so the total result hydraulic force on piston 4 will be towards the front and stops its returning movement. However, the pressure pulse will be created because of the inertia of piston 4. The pulse pressure will act on the rear side of piston 15 through port 9, 11, 12, annular 7 and port 10. The hydraulic force pushes piston 15, further piston 4 forwards. Plus the hydraulic force on the annular area 1, the piston 4 gets acceleration and will move faster than the conventional designs without the piston 15. As piston 4 moves forward to the position at which the annular 8 connects port 12 and 13. The rear floating piston 15 will be pushed back by spring 20 and the trapped oil in chamber 6 flows to tank 19, ready for next cycle. Piston 15 will potentially not only dampen the pressure pulsation in chamber 1 and the connecting circuits, but also accelerate the impact movement of piston 4.

What is claimed is:

1. A hydraulic drifter, comprising:
a hammer case 3 with an inner bore hole having a plurality of inner surfaces,
an impact piston 4 having a plurality of outer surfaces accommodated in said hammer case, moving back and forth axially along the said bore hole,
the plurality of inner surfaces of the bore hole mating with the plurality of outer surfaces of the piston 4, confining a front chamber 2 and a rear chamber 1,
oil channels being provided in the case body to divert oil to and from chambers, the direction and flow of oil been controlled by a distribution valve 14, which is defined by prior art,
a second bore hole within the case body of said hammer or a separate body detached to it,
a floating piston 5 accommodated in the second bore hole, moving back and forth axially,
oil channels 16, 17 been provided to connect the chambers 2a, 1a, which are confined by two ends of the floating piston 5 and the inner surface of bore hole, with said front chamber 2 and rear chamber 1.

2. In combination with claim 1, a hydraulic drifter comprising:
a rear floating piston 15 having plurality outer surfaces implemented behind the impact piston 4, mating with plurality of inner surfaces of said bore hole, confining a front chamber and a rear chamber 6,
a spring 20 in the front chamber,
oil ports 9,10, 11,12 being provided in the case body to divert oil to and from rear chamber 6, and the oil been controlled by the ports and annular grooves 7, 8 on the surface of said impact piston 4,
wherein the piston 15 can axially move forward by oil pressure and backward by spring force.

3. A DTH hammer impact piston that has a floating piston which is accommodated in a bore hole inside it, the two chambers confined by the floating piston and the bore hole are connected with the hammer chambers respectively in which the pressure fluid drives the impact piston.

4. A hydraulic hammer breaker that has a floating piston accommodated in a bore hole inside the impact piston or the case body of the hammer, wherein the two chambers confined by the floating piston and the bore hole are connected with the oil chambers respectively in which the pressure oil drives the impact piston.

5. In combination with claim 1, claim 3, claim 4, the floating piston is made of aluminium or its alloys. Its outer surface can be a straight cylinder or with plurality features.
